(19) United States
(12) Patent Application Publication
(10) Pub. No.: US 2011/0320317 A1
(43) Pub. Date: Dec. 29, 2011

(54) IMAGE CAPTURE FOR PURCHASES

(75) Inventors: Jian Yuan, Mountain View, CA (US); Yushi Jing, Mountain View, CA (US)

(73) Assignee: Google Inc., a Delaware corporation

(21) Appl. No.: 13/222,292

(22) Filed: Aug. 31, 2011

Related U.S. Application Data
(63) Continuation of application No. 12/143,233, filed on Jun. 20, 2008.

(51) Int. Cl. G06Q 30/00

(52) U.S. Cl. 705/26.61

(57) ABSTRACT

The subject matter of this specification can be embodied in, among other things, a computer-implemented item identification method that includes identifying an item in an image received from a remote electronic device; transmitting search results containing information about the item for one or more vendors of the item; and transmitting to the remote device code for executing an order for the item from the one or more vendors of the item.

### TECHNICAL FIELD

This document generally describes using captured images, such as from mobile devices, to assist in purchasing items from the images.

### BACKGROUND

Shopping is nearly a national pastime. People spend weekends at the malls, and travel miles out of their way to locate great bargains. Shopping, at least in bricks-and-mortar stores, is also decidedly low tech. Shoppers pick up the product try it out, take a peek at a price tag, and walk over to a checkout area where they pay for their goods by cash, check, or credit card.

In looking at an item to determine whether to purchase it, a shopper generally has an idea of what they want and whether it is a good deal. They may have done some on-line research before going shopping to obtain additional information, or could use a mobile device such as a smartphone with a web browser to find additional information.

### SUMMARY

This document describes techniques for identifying a physical item and purchasing the item on-line. In general, a shopper may acquire an electronic image of an item that they are interested in purchasing and may submit the image to a remote server along with instructions indicating their interest in receiving product-related information. The server may attempt to match the image to various stored images of products that are in turn linked to meta-data about various objects that help identify the objects. With such identifying information in hand, the server may then submit the information to a product search system and may return to the mobile device a list of search results for items that are for sale that match the item in front of the user. The server may also integrate data from a payment system so that the user may immediately purchase products from one of the vendors shown in the search results.

In this manner, a user may conveniently comparison shop for items, both between and among various on-line vendors and between a bricks-and-mortar store and on-line vendors. The user may also readily convert such comparisons into a consummated purchase. Such a purchase may be made through a third-party that differs from any of the vendors, such as through Yahoo! Shopping, so that the user need not submit credit card or other similar data to the vendors.

In a first general aspect, a computer-implemented identification method is described. The method includes identifying an item in an image received from a remote electronic device; transmitting search results containing information about the item for one or more vendors of the item; and transmitting to the remote device code for executing an order for the item from the one or more vendors of the item.

In a second general aspect, a computer-implemented item identification method is described. The method includes submitting to a remote server an image containing a physical item; receiving in response a list of items for sale from one or more vendors with a control for buying the items, wherein the items correspond to the physical item; and transmitting a command to purchase the item from one of the vendors.

In a third general aspect, a computer-implemented item identification system is described. The system includes an interface to receive digital images submitted by remote devices; an image comparator to compare features of the received images to features of stored images to identify products in the received images; and a product search engine to generate search results corresponding to search terms associated with the stored images.

In still another general aspect, a computer-implemented item identification system is described. The system includes an interface to receive digital images submitted by remote devices; memory storing a plurality of images containing products for sale by a plurality of vendors; and means for mediating a sale by a selected vendor from the plurality of vendors to a user of the remote device in response to a selection by the user.

The details of one or more embodiments are set forth in the accompanying drawings and the description below. Other features, objects, and advantages of the invention will be apparent from the description and drawings, and from the claims.

### DESCRIPTION OF DRAWINGS

FIG. 1 is a conceptual diagram of a system for capturing an image to purchase an item.

FIG. 2 is a schematic diagram of a system for capturing an image to purchase an item.

FIG. 3A is a flowchart showing actions taken to send images to compare for purchasing a product.

FIG. 3B is a flow chart showing an example of a process for using an image to provide purchasing options to a user.

FIGS. 4A and 4B are sequence diagrams depicting processes by which a client can obtain information about a product in an image by using various imaging and commerce servers.

FIG. 5 shows an example of a computer device and a mobile computer device that can be used to implement the techniques described here.

Like reference symbols in the various drawings indicate like elements.

### DETAILED DESCRIPTION

“Where did you get that?” is a commonly-heard phrase at many social gatherings. Often, the owner doesn't know where the item came from; the item may be a gift, or the owner may have purchased the item so many years ago that the origin is unknown. The store may have closed, or the owner may want to have that unique piece to herself among her circle of friends. The seeker can try searching the Internet, but sometimes items can be hard to describe. “Metallic scarf” can conjure several thousand websites, none which match the seeker's idea of what a metallic scarf looks like. Even if the seeker finds one metallic scarf, it can be an overpriced version, or from an unknown source. The seeker will be less likely to buy it without some ability to compare to another source.

In a like manner, a consumer who is shopping for products may see a product at a store and want to learn more about the product, such as technical specifications, country of origin, and other such information. The user may also want to comparison shop to see where the best price can be found.

In general, a user can take a picture of the item with a digital camera, such as a camera integrated in a smartphone or similar device, and transmit the image using a multimedia messaging service (MMS). The picture can be sent to an imaging server to be identified. Once identified, the picture can be used to find items for sale on by various vendors, and allow the user to purchase the item from a desired source. For example, the user can take a picture of her friend's scarf. The scarf picture is identified by an imaging server and different sellers are identified by another server. The user can choose the seller through a “one-button-to-buy” application. With the one-button-to-buy application, the user can securely transact with various sellers without having to visit a seller's website. Advantageously, the described system may provide for one or more benefits, such as reducing the time to find a desired item.

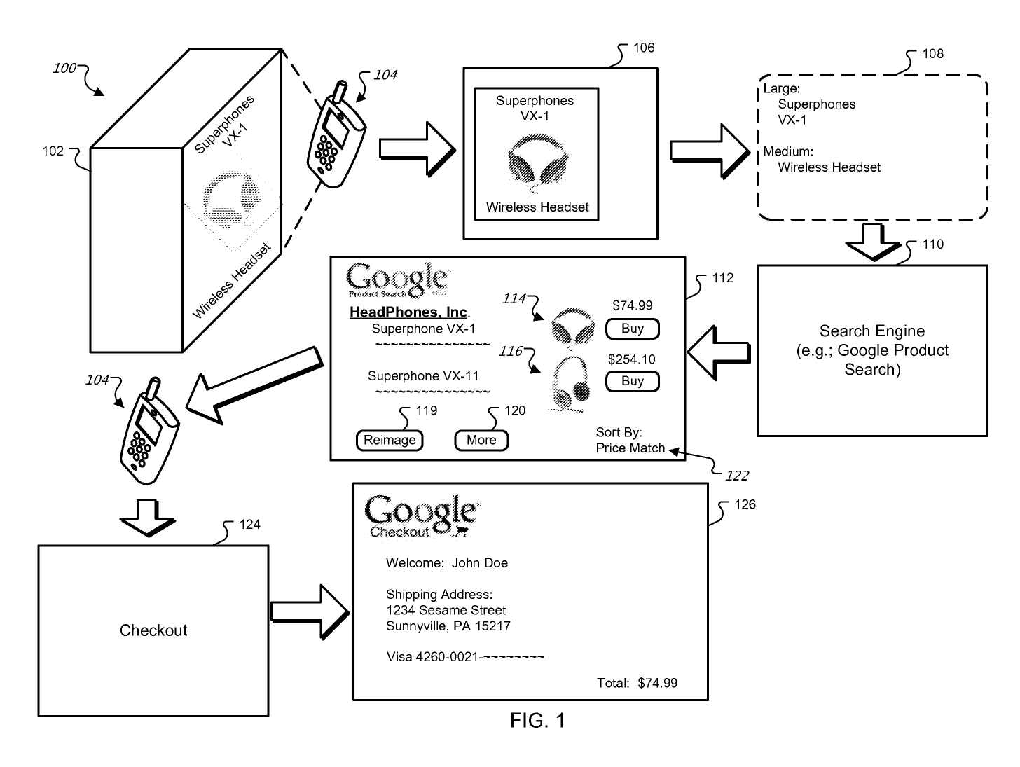

FIG. 1 is a conceptual diagram of a process 100 for capturing an image to purchase an item. In general, the process 100 allows a user to send an image of an item to a search engine to find multiple sellers and compare pricing for the item. Once the user has determined which product she wants to buy, she can purchase the item through a checkout service such as GOOGLE CHECKOUT.

Referring to FIG. 1, the user can initially identify an item 102 that she wants to purchase. Here, the item is in the form of a box holding a pair of stereo headphones, or the headphones themselves. Using a mobile device 104, the user can capture an image 106 of the item 102. The mobile device 104 may then transmit the image to a server, such as over the internet for analysis, as shown by the captured image 106.

The server or other structure can identify what the item in the image 106 is in various manners. For example, the server can identify feature points in the image 106. The feature points may be areas in which data in the image changes suddenly (e.g., sudden shifts in pixel colors or brightnesses), such as where the item stops and the background behind the item begins. The feature points may together represent a sort of digital line drawing of the object in the image, in effect.

Other images of the same and similar items may have been previously accessed by the system, with feature points generated for those images. Such other images may have been obtained along with meta-data about the items, such as the manufacturer and model name for the items. For example, manufacturers may have submitted images along with the meta-data, or a system may have crawled web pages from various vendors to extract such information from the unstructured web pages to turn it into structured data. The feature points in the image acquired by the user may then be compared to the feature points in the previously stored images to find a closest match, and the meta data for the matching image may then be used to identify the item in the image from the user.

For example, feature points can be based on discontinuities or differences from the surrounding points. Examples of the types of features that can be computed can be found, for example, in Mikolajczyk, K., Schmid, C., “A performance evaluation of local descriptors,” IEEE Transactions on Pattern Analysis and Machine Intelligence, 27(10), October, 2005, 1615-1630; and Lowe, D. G., “Distinctive image features from scale-invariant keypoints,” International Journal of Computer Vision, 60(2), November, 2004, 91-110 (Springer Netherlands), which are incorporated by reference here in their entirety. Other implementations are described further below.

With the item identified, tags 108 associated with the item may also be identified. For example, the item may be initially identified by an item number or another less-than-descriptive identifier, and the tags may be more descriptive, such as the name of model for the item. Such descriptive tags may then be sent to a search engine 110. The search engine may be directed to a product-specific index, such as the GOOGLE PRODUCT SEARCH service (f/k/a FROOGLE).

The search engine may then return a list of products, from vendors who currently have products for sale, along with links to the vendors and pricing information, formatted in a familiar manner. Such information may have been previously retrieved by the search engine directly from vendors (e.g., by vendors submitting data in a pre-approved format), manually (e.g., by agents copying information from vendor pages), semi-manually (e.g., by agents marking up portions of pages and automatic systems extracting product data from similarly-formatted pages), or automatically (e.g., by a crawler programmer to recognize product and pricing data, such as by being trained on a set of training data by various known machine learning techniques).

The search engine 110 results can then be passed to a commerce module that can use the tags 108 and/or the search result data to generate a one-button-to-buy display 112 for the various vendors in the search results. For example, the module may identify a particular vendor and pricing information associated with the vendor, and may generate mark-up code that will cause a visual “buy” control , e.g., in the form of a selectable button, to be displayed. Selection of the “buy” control by a user may trigger JavaScript or other code associated with the search result code transmitted by to the device, to cause the selected item to be added to a shopping cart or to cause the user to be taken directly to a checkout, such as the checkout screen from GOOGLE CHECKOUT. Generally, in such a situation, the vendors would need to have previously associated themselves with the service, so that purchasing buttons would only be displayed next to results for such pre-approved vendors.

As shown, the one-button-to-buy display 112 can be sent to the mobile device 104 to provide the user with various products, such as a close match 114 and similar match 116. The display 112 can contain a reimage button 118 to provide different search results based off the same picture. The one-button-to-buy display 112 can also contain a more button 120 to allow the user to view other matches from the current search.

Information associated with each search result may also be presented in the form of a hyperlink that connects to a web page for the particular vendor. The user may select the hyperlink to be taken to a web page for the vendor. Such a selection may permit the user to see additional detail about the product, such as technical specifications, to verify that the offered product is the same as or equivalent to the product in front of the user, to verify that the vendor is legitimate, and to verify that the displayed price is accurate.

Matches can be sorted from sort selections 122 within the one-button-to-buy display 112. For example, the matches may be sort from closest visual match to more distant visual matches, or by price, among other things. The user can select a match on her mobile device 104. The mobile device 104 can send the choice to a checkout server 124, which can generate a display to provide the user with a confirmation display 126.

The display 112 can provide the user an efficient way to purchase items securely through her mobile device 104. In some implementations, the user can have data stored through her mobile device 104 that will allow her to make purchases without having to enter personal information. For example, the user can have data stored through a GOOGLE CHECKOUT account. The display 112 can also allow the user to make a purchase without having to go directly to the seller's website in such a situation. As a result, the user may have provided credit information to a single trusted source, but may transact business with numerous unknown vendors without having to give them credit information.

In other implementations, the user can navigate to the seller's website to buy directly from the seller. Likewise, the user can provide the seller with her personal information to make a purchase. The display 112 can also have various display configurations, as discussed further below.

In some implementations, the search engine 110 can display preferred vendors, or only display vendors that have registered with the search engine. In other implementations, the tags 108 can be sent to an auction search engine. Likewise, the user can be given options as to which search engine 110 she wants to use to make her purchase. In still other implementations, the process 100 can use multiple search engines to display matches to the user.

As discussed above, the search engine 110 can provide close matches 114 and similar matches 116. FIG. 1 shows the close match 114 as being the same model number and brand as the item 102. In some implementations, close matches 114 can be matches that are not the same product as the item 102. For example, the close match 114 can be a product that has the same features as the item 102, but is not the same brand. The close match can also be an item that corresponds to an image that was a close, but not close enough, match to the submitted image. As shown in FIG. 1, the similar match 116 is the same brand as the item 102, but is a different model. In some implementations, similar matches 116 can be matches that are not the same brand or the same model as the item 102, but a product related to the item 102. For example, the item 102 can be headphones shown in FIG. 1, and the similar matches 116 can include products such as generic versions of the headphones and headphone cases. In other implementations, the search engine 110 can return only close matches 114.

Where no stored image adequately matches the image 106 submitted by a user, the system may ask the user to obtain a better image. For example, the image 106 may be determined to have insufficient illumination. The system may, in such a situation, decide that a sufficient match can only be made if the image 106 is resubmitted with a higher illumination. As such, the system may return a message to the device 104 instructing the user to take another image using a flash, using an alternative light source, or may instruct the user in a similar manner. Likewise, the image may be determined to have insufficient resolution. As such, the system may return a message to the device 104 instructing the user to take another image using a higher resolution, to step closer to the item 102, to zoom in on the item 102, or may instruct the user in a similar manner. The system may also simply find no result and request that the user take another image using different settings. The processing and comparison of the subsequent image may occur in a manner like that for the original image 106. If no match can be made, the system may so notify the user.

In some implementations, the reimage button 118 can provide the user with the option of having the image 106 evaluated again to generate different tags 108. For example, if the user wants headphones, but the image 106 also contained an mp3 player, the reimage button 118 can provide data that the mp3 player is not the item 102 the user wants. In other implementations, the image 106 can be displayed on the mobile device 104, allowing the user to designate the area of the image 106 where the item 102 is located. In yet other implementations, if the item is earmuffs, and the initial result shows headphones, a re-imaging operation may cause an imaging server to change the parameters that it uses in its image comparison process so as to produce results that differ substantively from the first round of results.

The more button 120 can provide the user with matches that are less related to the item than are shown in the first one-button-to-buy display 112, when the items are sorted by level of match, or that cost more if the items are sorted by price. In other implementations, the more button 120 can provide different search engine options to the user. For example, if the display 112 has multiple close matches 114, and initially lists vendors that are not familiar to the user, the user may want to purchase from a highly-ranked seller and can ask to see more results. Using a ratings option in the sort selections 122, the user can move the highest-rated sellers to the top of the listing also.

As described previously, image matching can be computed using various methods. For patch-based features, patches can be normalized to a canonical orientation, for example, by rotating a sub-image such that it is always brightest on top, or through various other schemes also described in the above references. Other approaches allow patches to be scale invariant or invariant to affine transformations. In some implementations, visual similarities can be used to identify an item in an image. In one approach, a similarity function can be defined for feature points. Comparison functions can range from simple to complex. Methods for comparing two images are known in the art; complex matching functions using geometric information to validate two sets of feature points can be found, for example, in Lowe, D., “Local Feature view Clustering for 3D Object Recognition,” IEEE Computer Society Conference on Computer Vision and Pattern Recognition (CVPR'01), Vol. 1, 2001, 682; Lowe, D., “Distinctive Image Features from Scale-Invariant Keypoints,” International Journal of Computer Vision, 60(2), 2004, 91-110; Rothganger, F., Lazebnik, S., Schmid, C., Ponce, J., “3D Object Modeling and Recognition Using Local Affine-Invariant Image Descriptors and Multi-View Spatial Constraints,” IEEE Computer Society Conference on Computer Vision and Pattern Recognition (CVPR'03), Vol. 2, 272-277, 2003; and Grauman, K., Darrell, T., “The Pyramid Match Kernel: Discriminative Classification with Sets of Image Features,” Tenth IEEE International Conference on Computer Vision, Vol. 2, 1458-1465, 2005, which are incorporated by reference herein in their entirety.

In other implementations, the image 106 can be determined in whole or in part using optical character recognition (OCR). For example, the item 102 can be a book, which can have a title on the cover or an International Standard Book Number (ISBN). Alternatively, the item may be in a cardboard box with identifying information printed on it. The OCR information may be used, for example, to refine results that are based on an image-to-image comparison. Using the example above, if the image-to-image comparison provides close ratings for headphones and earmuffs, text in the image referencing “stereo,” “headphones,” or other such terms may be used to break a tie. Likewise, a determination may be made that the item is in a rectangular box, and stored images relating to headphones may include images of rectangular boxes, while stored images of earmuffs may not. Such information may also be taken into account, such as when other indicators are indeterminate.

In some implementations, the display 112 can have a search area to provide an area in which the user can enter alphanumeric search terms to narrow down a larger listing of matching items. For example, if the process 100 returns a listing of over 5,000 matches for a blue hat, the user can narrow the search with the term “wool.” Likewise, the display 112 can display specific price ranges or names of vendors or manufacturers to allow the user to narrow her search and more accurately match the item 102 she photographed. In other implementations, the device 104 can be GPS-enabled to provide further data to the system. For example, if the user is in a TARGET, the image can be matched with a catalogue provided by TARGET. In still other implementations, the image 106 can include a landmark, allowing the system to match the image to travel-related images. For example, the image 106 can include a portion of the Golden Gate Bridge, allowing the system to match the image with Street View data.

The user can find the item 102 she wants to purchase in a variety of situations. The item 102 that a user wants to purchase can be an item she sees in everyday life. For example, the user can search for an item such as headphones, a book, clothing, or a car. Alternatively, the user can find the item 102 through the media, such as in a television show or a magazine. Instances where the user is searching for an item that is not available for public consumption is discussed further below. A user taking multiple images to submit as a collection is also discussed further below.

Although the image 106 can typically be taken by the user with her mobile device 104, the image 106 can be obtained in a variety of other ways. In some implementations, the user can download images from various sources, such as the Internet, from a camera, and from picture messages from friends. For example, a daughter can send a picture of a scarf to her mother, asking for the scarf for her birthday. The mother can use the picture in the system to purchase the scarf for her daughter.

The mobile device 104 is intended to represent various forms of devices such as personal digital assistants, cellular telephones, smartphones, and other similar computing devices. In general, the device is capable of MMS communication and may be capable of other modes of communication. The mobile device 104 can have a built-in camera to capture the image 106 or the mobile device can upload the image 106 through devices such as an SD card, through BLUETOOTH enabled devices, or through the internet.

Although purchasing items has been discussed, the system can be implemented for other activities. For example, the user can see a print ad for a movie. With a picture of the ad, the process 100 can determine the movie, provide the user with reviews of the movie, and provide a listing of movie theatres nearby using the location of the mobile device 104 as a reference, or a stored “home” location for the user as a reference. In other implementations, the process 100 can be used to determine ingredients in food. For example, if a user wants to find the recipe for a dish at a restaurant, the user can take a picture of the dish and run a search that can return matches to the picture. This implementation can be helpful to users who have food allergies or are on limited diets.

As discussed previously, the user can also search for an item that is not available for public consumption. For example, the user can store an image of a movie in order to purchase the DVD when it comes out several months later. Likewise, the user can store images that are available for sale to search at a later date. For example, if the user is shopping for several people for the holidays, the user can walk around a mall and take images 106. After the day is over, the user can sort through the images 106 to determine which ones she wants to purchase, and may then submit the images to a system to learn more about the items in the images.

As discussed previously, the user can provide the system with multiple images, submitting them as a collection. In one implementation, the user can provide images of a NIKON D40 camera and a SONY camera. The system can use one image to help refine the other. For example, if the system has clearly identified second image as a SONY camera, but the first image of the NIKON D40 camera is not easily determined, the system can use the second image and its properties to clarify its search for the first image. In other implementations, the user can save particular images as a collection and submit a new image as being part of that collection. The new image can be searched within the saved parameters of the previously saved collection. For example, the user can save the NIKON D40 camera image and the SONY camera image, and then take an image of a CANON camera. The new image can be determined using the previous parameters to narrow the search.

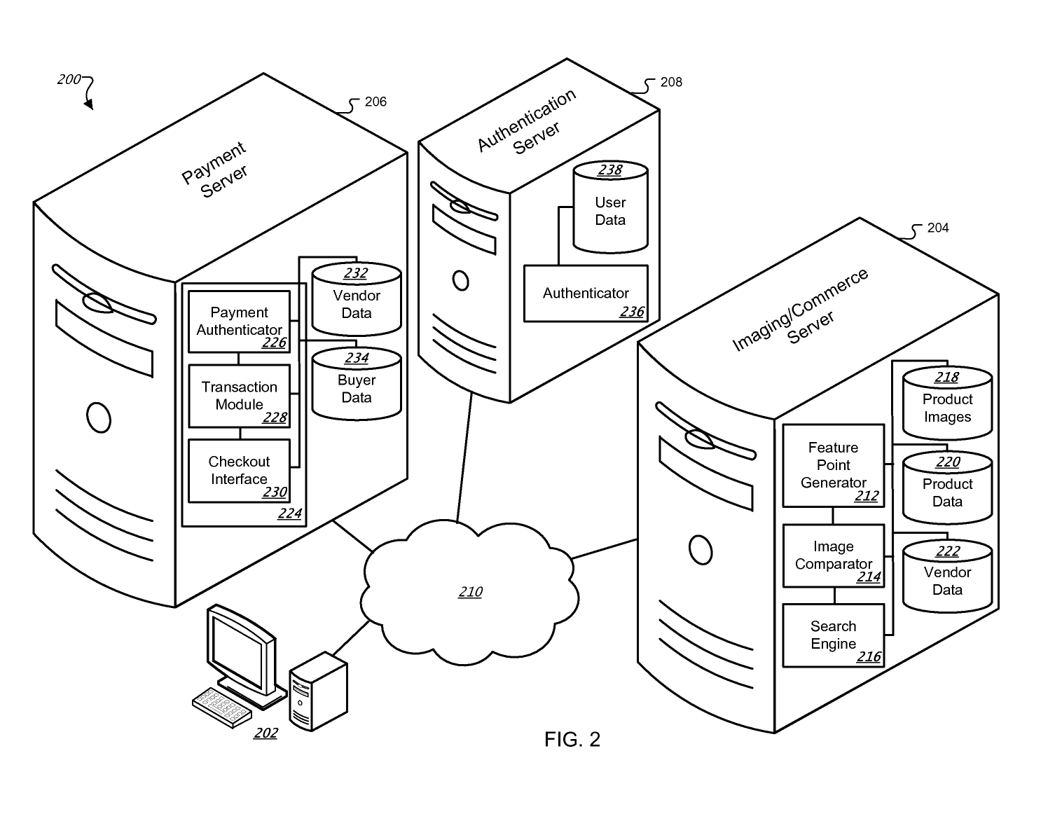

FIG. 2 is a schematic diagram of a system 200 for capturing an image to purchase an item. The system 200 includes a computing device 202, an imaging/commerce server 204, a payment server 206, and an authentication server 208. Here, the computing device 202 can transmit an image of a desired item through the internet 210 to the imaging/commerce server 204. The imaging/commerce server 204 can find products that match the item by using the image provided by the computing device 202. The imaging/commerce server 204 can transmit a list of matching products to the computing device 202 to allow the user to determine if she wishes to purchase any of the matching products.

If the user selects one of the matching products, the computing device 202 can transmit the user's selection to the payment server 206. The payment server 206 can provide user information to a vendor and vendor information to the user to process the user's purchase. The payment server 206 can request user authentication from the authentication server 208 for payment information. Once the payment server 206 receives authentication information, the payment server 206 can transmit confirmation data to the computing device 202. For example, a user may want to purchase a scarf she saw in the subway. She can take a picture of the scarf and upload it to the imaging/commerce server 204 to find vendors through the payment server 206 to purchase the scarf.

The imaging/commerce server 204 has several components that can be used to identify the item in the image and search for matching products. For example, the imaging/commerce server 204 can have a feature point generator 212, an image comparator 214, a search engine 216, a product images data source 218, a product data source 220, and a vendor data source 222.

The feature point generator 212 can analyze the image to determine feature points. As discussed further above and below, the feature point generator 212 can use various methods to determine the item within the image. The image comparator 214 can use the feature points from the feature point generator 212 to determine tags that represent the image, or to identify matching figures that are already tagged. To find matching products, the search engine 216 can use the tags derived from the feature points.

Data sources in the imaging/commerce server 204 can provide comparison information to provide better matching data. The product images data source 218 can provide known products with feature points already attached. For example, if an image has the same feature points as a product image in the product images data source 218, the image comparator 214 can identify the match and then determine the product tags from the matched image. To determine the product tags, the product data source 220 can include feature tags that match feature points for product images. As discussed further below, the tags can be determined via a variety of implementations.

The payment server 206 has several components that can be used to allow the user to purchase an item. The payment server 206 can have a payment module 224 that includes a payment authenticator 226, a transaction module 228, and a checkout interface 230. The payment server can also include a vendor data source 232, and a buyer data source 234. One example of a payment server 206 is the group of servers that provide GOOGLE CHECKOUT functionality. In such an example, the standard CHECKOUT interface may be used, and the imaging/commerce server 204 may simply pass mark-up code to the device 202 that, when executed on the device 202, redirects the device 202 to the payment server 206 for completing a transaction.

The payment module 224 can receive a request to purchase a product from the computing device 202. To process a payment, the payment module can determine a secure transaction using the payment authenticator 226. In some implementations, the payment authenticator 226 can request authentication from the authentication server 208. Such authentication may occur, for example, where the user logs into the system by the authentication server 208 either before or after requesting a transaction. With an authenticated transaction, the transaction module 228 can provide the vendor with the necessary information to process the user's payment and to ship the product to the user's desired shipping address. The checkout interface 230 can use data to generate a display for the computing device 202 to create a purchase confirmation page for the user. As discussed further below, the payment module 224 can complete the transaction without requesting more information from the user through the computing device 202.

Data sources in the payment server 206 can provide information to communicate between the user and the seller. The vendor data source 232 can provide information to transact with the vendor. For example, the vendor data source 232 can contain contact information and a routing number for payment. The buyer data source 234 can contain information to provide the vendor with information from the user. For example, the buyer data source 234 can include shipping and billing addresses, where the shipping address information may be passed to the vendor so that the vendor knows where to ship an item. In some implementations, the vendor will never directly receive credit card information, but only receive confirmation that the buyer has been authenticated. In other implementations, the buyer data source 234 can include credit card information sent directly to the vendor.

The authentication server 208 has several components that can be used to authenticate the user's payment information to allow for a secure transaction. The authentication server 208 can have an authenticator 236 and a user data source 238. The authentication server 208 can receive an authentication request from the payment server 206 and authenticate the computing device 202 to purchase the product. For example, the user can sign into an account on the computing device 202 that can access the user's previously entered banking information.

The data source for the authentication server 208 can provide user-specific payment information to the system 200. The user data source 238 can provide information such as credit card information, bank account routing information, and security information. For example, the user's credit card number and security code can be stored in the user data source 238 so that the user does not have to enter the information each time she makes a transaction.

As discussed previously, product tags can be determined via a variety of implementations. For example, the feature point generator can determine feature points on the image by finding variation in a subject feature from surrounding features. In other implementations, the feature point generator 212 can use OCR to determine text-based tags for the search engine 216. For example, if the image contains packaging with the terms “headset,” “Superphones,” and “VX-1”, as the image 106 does in FIG. 1, the search engine 216 can use these terms as tags. In still other implementations, the feature point generator 212, image comparator 214, or search engine 216, can determine a unique code for a product on the image, such as a Universal Product Code (UPC) or an ISBN.

In some implementations, the payment module 224 can receive the purchase request from the computing device 202 and process the purchase with no further information from the user. This type of transaction can provide an efficient and secure means of purchasing the product. In other implementations, the user may want to purchase an item with different payment methods than already available. For example, if a wife wants to purchase a new television for her husband's birthday, but they have a joint banking account set up for online purchases, she may not want to use that account so she can keep the present a surprise. The payment authenticator can receive a request from the computing device 202 to use different payment information than is available through the buyer data source 234. In such an instance, the payment server 206 can either process the transaction directly or allow the vendor to process payment information.

As discussed previously, the authentication server 208 can provide a secure transaction for the purchase without requiring the user to input her personal information for each transaction. In some implementations, the authentication server 208 can provide data from the user data source 238 regarding a specific user account. For example, the user can have an account with her credit card information stored, such as GOOGLE CHECKOUT, to provide payment to the vendor without providing the vendor with her credit card number or other sensitive data. In other implementations, the authentication server 208 can directly provide information to the vendor.

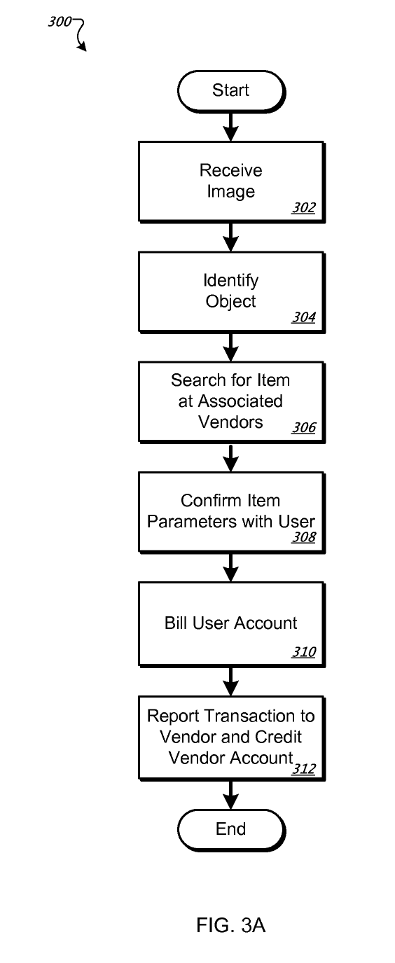

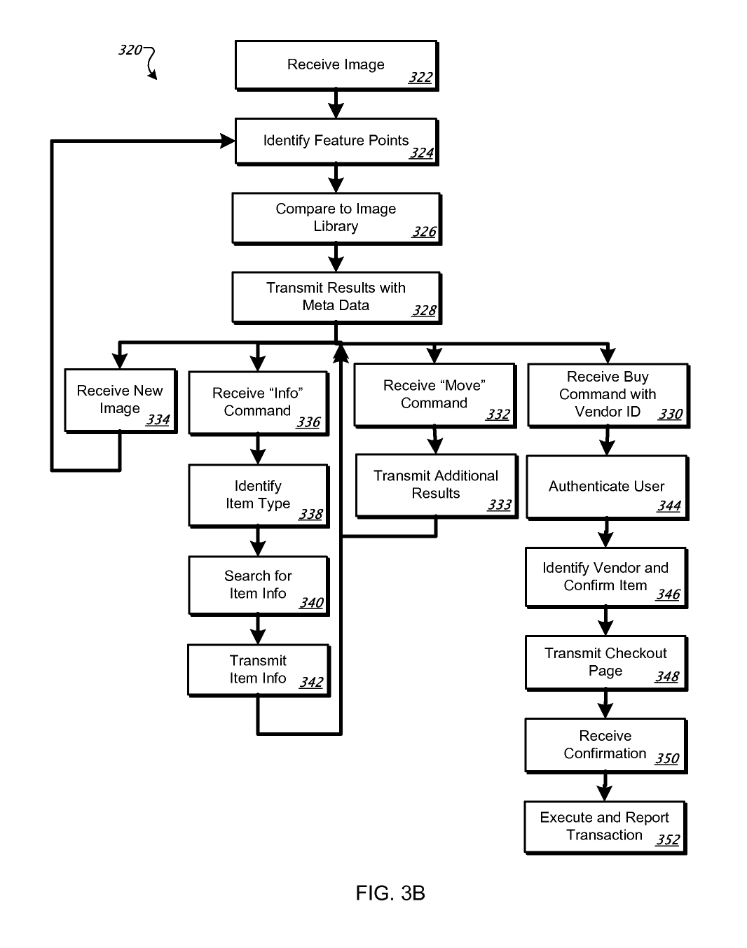

FIG. 3A is a flowchart showing actions taken in a process 300 to send images to compare for purchasing a product. The process 300 generally involves receiving an image, identifying an object in the image, searching for an item at associated vendors, confirming the item parameters with a user, billing an account of the users, and reporting the transaction to a vendor and crediting the vendor account.

At an initial step, the process 300 receives (box 302) an image. For example, a user can photograph an item she wants to purchase. The image created can be uploaded using the process 300 so that it can be analyzed. As one example, the user can photograph a scarf she sees a friend wearing. The image of the scarf can be received to determine information regarding the image.

The process 300 then identifies (box 304) an object in the image. For example, the image can contain the scarf. The scarf can have specific feature points that can be identified using variation in the item from surrounding features. For example, the scarf fabric may be made of a metal mesh, with discs connected to form the fabric. The light reflecting from the material can provide a source of information to the feature points as dramatic shifts in light reflection are available. Feature points can be identified in a variety of ways mathematically, as described further below.

The item is then searched at associated vendors (box 306). For example, preferred vendors can be identified prior to the transaction for a specific item. In other implementations, all vendors can be searched for the item. As one example, any site with the scarf mentioned can be determined, and then sites with the ability to sell the scarf can be retrieved. In certain implementations, the scarf can be identified as a scarf, but the particular scarf might not be located. In such a situation, the search may simply be made for scarves in general, and the user can browse within the returned result for one that looks like the scarf that interests them.

The process 300 then confirms (box 308) the item parameters with the user. For example, the closest matches to the scarf in the image can be displayed to the user so that she can determine from which vendor she wants to purchase the scarf. In some implementations, the user can request to upload a new image. In other implementations, the user can request that the object in the image be identified again. In still other implementations, the user can ask for more matches from the original search.

In the example discussed here, the user can purchase the scarf from ReGifts in Minneapolis using a “one-button-to-buy” application, where ReGifts is a registered vendor with, for example, GOOGLE CHECKOUT. (If ReGifts is not registered, the transaction may be booked provisionally, the payment system can contact ReGifts with an indication that it has an order, and the managers of ReGifts can determine whether to sign up and complete the order.) The application allows the user to purchase the scarf without having to provide further information, as discussed below. The one-button-to-buy application also allows the user to compare different vendors and purchase the scarf without having to navigate to any of the vendors' websites.

At box 310, a user account is billed. For example, once the user has determined she wants to buy the scarf from ReGifts, her account can be billed without requiring her to provide any further information. As discussed previously, the billing information can be obtained from the user account, such as a Google Checkout account. The user account can contain information such as credit card information or checking account information.

In some implementations, sites using different languages or currency from the user can be displayed if they can transact with a non-local buyer. For example, if the desired item is a Hello Kitty purse, a Japanese website may be selling the purse. In some implementations, vendors can predetermine whether they want to sell items to various countries. In other implementations, the process 300 can determine from data within the vendor's website (e.g., by identifying currency symbols) whether or not the vendor can complete the transaction.

FIG. 3B is a flow chart showing an example of a process 320 for using an image to provide purchasing options to a user. In general, the process 320 involves receiving an image and comparing it (or more specifically, feature points form it) to an image library of pre-analyzed images that have already been associated with tags identifying items in the images. Where a match is made, the tags may be associated with the received image and applied to a search engine to produce results that can be transmitted to the user. The user may then be given a number of options for interacting with the results, as described in more detail below.

At an initial step, the process 320 receives (box 322) an image. For example, an image received through a picture message can be received. The image can be a specialty item that the user would like to buy. In some examples, the image can show a chocolate cupcake with chocolate ganache and buttercream frosting.

The process 320 then identifies (box 324) feature points in the image. For example, the feature points on the cupcake wrapper can be determined from its accordion shape using the shadows and lights in the image. The color palette of the image can also be used to determine potential matching flavors in the cupcake (e.g., chocolate versus lemon). A preliminary check can also be made at this point to determine if a particular item can be found in the image—for example, if the image is very out of focus, a contiguous group of points may not be found and the user can be told to submit a better image.

The process 320 then compares (box 326) the image to an image library. For example, the image of the cupcake can match an East End Chocolate Stout cupcake from Dozen Cupcakes in Pittsburgh. The image can also match a cookies-and-cème cupcake from Coco's Cupcakes in Pittsburgh. In other implementations, comparisons can be determined through a naming filter. For example, if the image file has a name, such as “cupcake”, the image library can be filtered to images having cupcakes in them. More likely, because various cupcakes are not very distinct form each other, the image could simply match an image associated with the tag “chocolate cupcake” or “lemon cupcake” or the like, and not a particular brand of cupcake.

Results of the comparison with vendor identification metadata are then transmitted (box 328). Such results may be search results generated by submitting tags associated with the matching figure to a product search system via a standard API. For example, images, descriptions, amounts, and pricing for each vendor's matching cupcakes can be transmitted. (If the tag simply indicates “cupcake,” a local search can be performed using the term cupcake or using related terms such as bakery.) In some implementations, the closest matches can be displayed so that the user can compare vendors and products. In other implementations, the results can be displayed by price. In still other implementations, the best match can be displayed first to allow the user to verify that the item was correctly identified. Also, matches, when in a local search mode, may be displayed as pins on a map and selection of an appropriate pin may show the user more information about the local vendor.

At box 330, a buy command with vendor identification is received. For example, a buy command for four East End Chocolate Stout cupcakes can be received. The buy command can be a one-button-to-buy command, initiating a purchase in a single step. In other implementations, the buy command can have a confirmation step to ensure the user intends to buy the cupcake, such as by showing the user a checkout screen with tax, shipping and other information computed. In addition, selection of the button may cause the item to be added to a shopping cart and the user may later remove it from the cart or choose to buy it along with other items that have since added to the shopping cart.

The process 320 then authenticates (box 344) the user. For example, the user can have an online account with financial information, such as a GOOGLE CHECKOUT account. The authentication can provide access to the user's account and allow the process 320 to access payment information.

The process 320 then identifies (box 346) the vendor and confirms the item. For example, Dozen Cupcakes can be the identified vendor for the four East End Chocolate Stout cupcakes. The process 320 can confirm that Dozen cupcakes sells East End Chocolate Stout cupcakes in groups of four via the Internet.

At box 348, a checkout page is transmitted to the user's device. For example, a checkout page can contain the vendor, the item, the amount of the item, the price, tax, and total of the item, the delivery date, and the shipping and billing information for the transaction. The checkout page can provide a receipt for the user. Alternatively, the checkout page can provide the user with an opportunity to confirm or reject the transaction.

Confirmation is received from the user (box 350). For example, the user may review the shipping, tax, and billing information and confirm that they would like to but (and pay for) all the items on the checkout page. Such confirmation may then trigger execution of the transaction, which will normally involve causing money to be removed from an account for the user and money to be added to an account for the vendor. A transaction fee may also be added to the user's price or taken from the vendor's sale price, as previously agreed to by the parties.

The process 320 then executes and reports (box 352) the transaction. For example, the transaction can be sent so that the vendor receives the order and the payment for the order. A report to the user can provide information such as a confirmation number for follow-up requests or to determine progress in shipping. In other examples, the vendor can receive the item, the amount, the desired date of delivery, and the shipping address.

Referring now to another branch in the process, in some implementations, the process can receive (box 332) a “more” command to retrieve more results (box 333) with vendor identification metadata. For example, if the user does not find a vendor from which she wants to buy cupcakes, the “more” command can retrieve different vendors for other purchasing options. In some implementations, the more command can provide other products that have been retrieved. In certain instances, the “more” command may return results that were not as close of matches as were the initial results; in other instances, the “more” command may cause a different search to be conducted that uses different parameters.

In another branch, the process 320 can receive a new image to identify its feature points (box 334). For example, the user can be a less-than-professional photographer and can realize, after the process's attempt to identify the item in her first image, that half of the desired item is missing from the image. A new image can be received to be identified and searched. Or if the results returned to the user's first submission are inadequate, the user may submit a new image on her own or at a prompting from the system.

In another branch, the process 320 can also optionally receive (box 336) an information command to request information of an item from the transmitted results. For example, information can be requested about a specific item listed, such as ingredients in a particular cupcake. After receiving the information command, the process 320 identifies (338) an item type. For example, the item type can be ingredients in the cupcake, can be technical specifications for an electronic item, or could simply relate to a URL for the vendor's web site, where the page is focused on the particular item. At optional step 340, the process 320 searches for item information. For example, the process can search the vendor's website for ingredients information. In other implementations, the vendor can supply predetermined items to allow the user to search information, such as ingredients, store hours, shipping costs, or stock availability. This information can be refreshed as needed or on a periodic basis. As a last step 342, the process 320 transmits the item information. For example, the ingredients of the cupcake can be transmitted to allow the user to determine whether she wants to continue with the purchase. Other item information can include a clip of a song off of an album or a trailer for a movie.

In addition to the four paths shown in illustrative examples here, other options may also be made available to a user. For example, the user can request an item in a different color than shown. The image may show a chair in a walnut finish, but the user may want the same chair design in a cherry finish. Such options can be shown to the user, the user can enter in the particular result, or the user can input another image with the desired option, here an image of cherry finish.

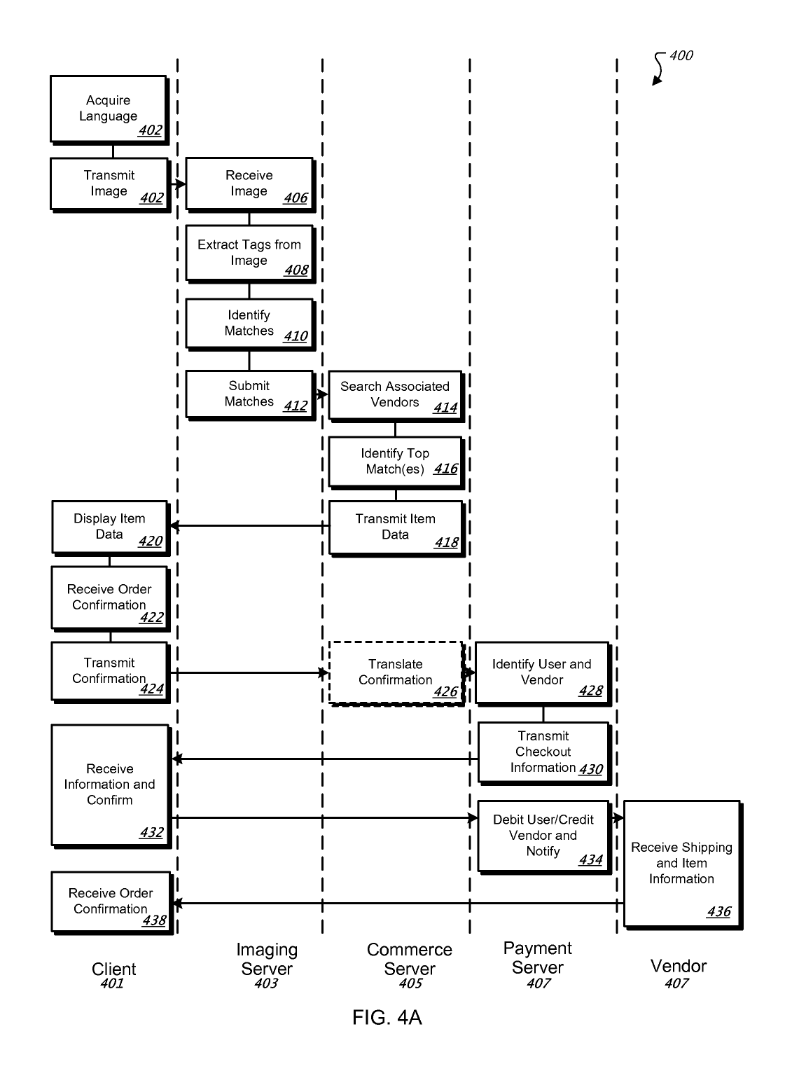

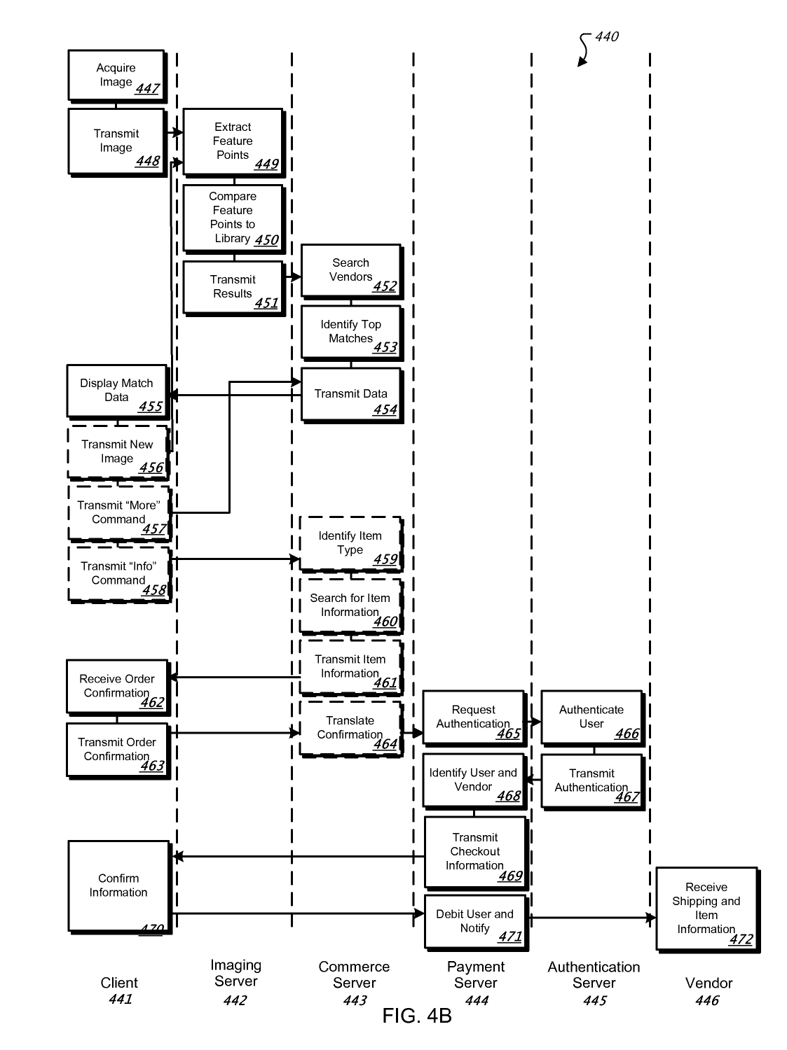

FIGS. 4A and 4B are sequence diagrams depicting processes by which a client can obtain information about a product in an image by using various imaging and commerce servers. In general, FIG. 4A shows a basic interaction by which the user submits an image via a client device and then orders an item from a set of results returned by the servers in the system. FIG. 4B generally shows a similar process, but where the user requests results in addition to the results initially returned by the system.

Referring now to FIG. 4A, initially, at box 402, the client device 401 acquires an image. The device 401 can acquire the image through a variety of methods, such as taking an on-device camera, receiving a picture message, or downloading an image from the Internet. Also, a user of the device 401 may simply right-click on an image on a web page, be presented with an option to learn about an item in the image, and may click a menu control to have such information provided.

The device 401 then transmits the image 404 to an imaging server 403. The imaging server 403 may include, for example, one or more servers that are part of an online information provider such as GOOGLE, that are configured to recognize and provide matching images to the uploaded image.

At box 408, the imaging server 403 extracts tags from image data, such as text, codes, shapes, or pictures. For example, the image can include a headset, as shown in FIG. 1, with the words “headset,” “Superphones,” and “VX-1”, a UPC code, and the shape of the physical object. The imaging server 403 can determine matches at box 410. In some implementations, the imaging server 403 can have a previously analyzed group of images with associated feature points. Tags may be associated with those images (e.g., if the images were taken from a web page containing the tags) and the tags may be assigned to the submitted image if the images match each other to a sufficient degree. With information regarding matches for the image, the imaging server 403 can submit the matches (box 412) to the commerce server 405.

The commerce server 405 then searches associated vendors at box 414. In some implementations, the commerce server 405 can have a predetermined vendor list from which it can search for a particular item or items. For example, it may search vendors that have previously registered with the payment system that operates payment server 407 (so as to ensure that all search results can produce a transaction through the payment system). In other implementations, the commerce server 405 can search all vendors on the internet or some large subset of vendors. An example search system of this type is GOOGLE PRODUCT SEARCH. Once the commerce server 405 has a list, the commerce server 405 identifies top matches at box 416. Top matches can be determined by such features as similarity to the item or pricing. In other implementations (e.g., when product search is combined with local search), the top matches can be determined by the proximity of the physical address of the vendor to the physical location of the client 401. At box 418, the commerce server 405 then transmits item data to the client 401.

With the top matches list from the commerce server 405, the client device 401 uses the data to generate a display of the item data at box 420. For example, the client device 401 can generate a display including the top five matches to the image, including various products that may be the same product as in the image or a different manufacturer or product type. In other implementations, the client device 401 can generate a display that has only exact matches. In still other implementations, the generated display can have one result to request verification from the client device 401 that the correct item is identified.

The client device 401 then receives an order confirmation from its user at step 422 to purchase a particular item. For example, the user can select a button to buy an item from a particular vendor using a one-button-to-buy application. In other implementations, the client device 401 can receive information from the user regarding the item, the amount, and shipping and billing addresses. Likewise, the client device 401 can also generate a display of the vendor's website. Once the order confirmation is received, the client device 401 transmits the confirmation at box 424.

The confirmation from the client device 401 can be sent directly to a payment server or may be passed through commerce server 405. For example, in a secure transaction with personal data sent from the client device 401, encryption can be used to protect the user, and the order can go directly to the payment server 407 (e.g., the commerce server 405 may format the mark-up code for the search results so that selection of a result causes a client device 401 to send an appropriately formatted message to the payment server 407).

Whether or not the confirmation is translated by the commerce server 405 before reaching the payment server 407, the payment server 407 receives the confirmation and, at box 428, identifies the user and the vendor in the confirmation. For example, the vendor can be HeadPhones, Inc., as shown in FIG. 1. The payment server 407 can identify the contact information and payment information for HeadPhones, Inc. and for the user.

Once the user and vendor are identified, the payment server 407 transmits checkout information at box 407 to the client. In some implementations, the checkout information can be information from an online account, such as GOOGLE CHECKOUT. The checkout information may include, for example, a sales tax amount and shipping and handling expenses. The payment server 407 may use information it has on the user and the vender to determined, for example, the distance an item will need to be shipped and may apply a standard shipping charge or a vendor-specific charge to the order before asking the user to confirm the order.

The client device 401 then receives the checkout information and confirms the checkout information (box 432), such as by the user selecting an “order” control or the like. The confirmation is sent to the payment server 407, which then debits the user's account and credits the vendor's account and notifies the vendor 409, at box 434. At box 436, the vendor 409 receives the shipping and item information from the payment server 407. The client 401 receives the order confirmation at box 438.

Referring now to FIG. 4B, a client device 441 initially acquires an image, such as by the various manners described above and transmits the image to an imaging server 442. At box 449, the imaging server 442 extracts feature points from the image. In some implementations, the feature points of an image can be extracted using the variations in an item from surrounding features. Once the feature points have been determined, the imaging server 442 can then compare the feature points to a library at box 450. For example, the feature points of the imaged item be compared to feature points of stored images in manners like those discussed above, and tags associated with the matching images may be transmitted to a commerce server 443 (box 451).

With the comparison results, the commerce server 443 searches an index of items from various vendors (box 452), and identifies top matches from the search results (box 453). The commerce server 443 can then transmit the data from the top matches to the client device 441 at box 454, and the client device can display the data (box 455).

In the pictured example, the user either did not like the results, decided not to buy the item, or decided to take another picture, so that the client device 441 transmits a new image at box 456, and the image matching and item searching may be repeated. The user may also transmit a “more” command which will use the results of comparisons of the first-submitted image to obtain additional matches, much like selecting a second page of search results from a standard search engine. As another option, a user may select an “info” command, which may cause the commerce server 443 to identify a type associated with the item (box 459) and to then search for item information using the type determination (box 460). For example, if the item type is a food item, the search may be tuned to gather nutritional information, whereas if the item is a piece of consumer electronics, the search may be aimed at obtaining technical specifications for the item. The commerce server 443 may then transmit the item information that is located (box 461), whose display may lead to the user indicating that they would like to confirm their order (box 462).

The order confirmation by the user may involve the user selecting a displayed “buy” button or the like, and may involve actions to add an item to a shopping cart and to indicate that all items in the cart should be submitted to a checkout process.

With the confirmation transmitted (box 463) to the commerce server 444 (box 464) for translation and forwarding to the payment server 444 (box 464), or directly to the payment server 444, the payment server 444 can begin closing out the transaction. For example, the payment server 444 may check to determine whether the user has previously, during the current session, logged into a central service such as logging into the various GOOGLE services with a single sign on. Such a check may be made by requesting authentication of the user, and perhaps of the vendor, from an authentication server 445 (box 465). The authentication server 445 may then authenticate the user, either by confirming that the user is currently signed on or by instituting a dialog with the user to get then logged on (box 466), and may then transmit an indicator that the user is authenticated back to the payment server 444 (box 467), which may in turn identify the user and the vendor. Such identification may permit the payment server 444 to complete a number of actions such as determining which accounts to debit and credit, where to instruct the vendor to ship goods, etc.

From such gathered information about the items, the user, and the vendor, the payment server 444 transmits checkout information to the client deice 441. Such information may take a familiar form, such as a listing of selected items, a sub-total cost, and a total cost that takes into account factors such as shipping and sales tax, among other things (box 469).

Upon being presented with the checkout page, the user may confirm that they would like to place the order (box 470) and the payment server 444 may debit the user and notify the user back with, e.g., an order confirmation, shipping updates and the like. The payment server may likewise notify the vendor 446 (box 472), such as to provide the vendor with a name and address for shipping, a description and quantity of the goods to ship, and a confirmation that the vendor's account will be properly credited if the goods are shipped.

Although a few implementations have been described in detail above, other modifications are possible. Moreover, other mechanisms for capturing an image to purchase an item may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

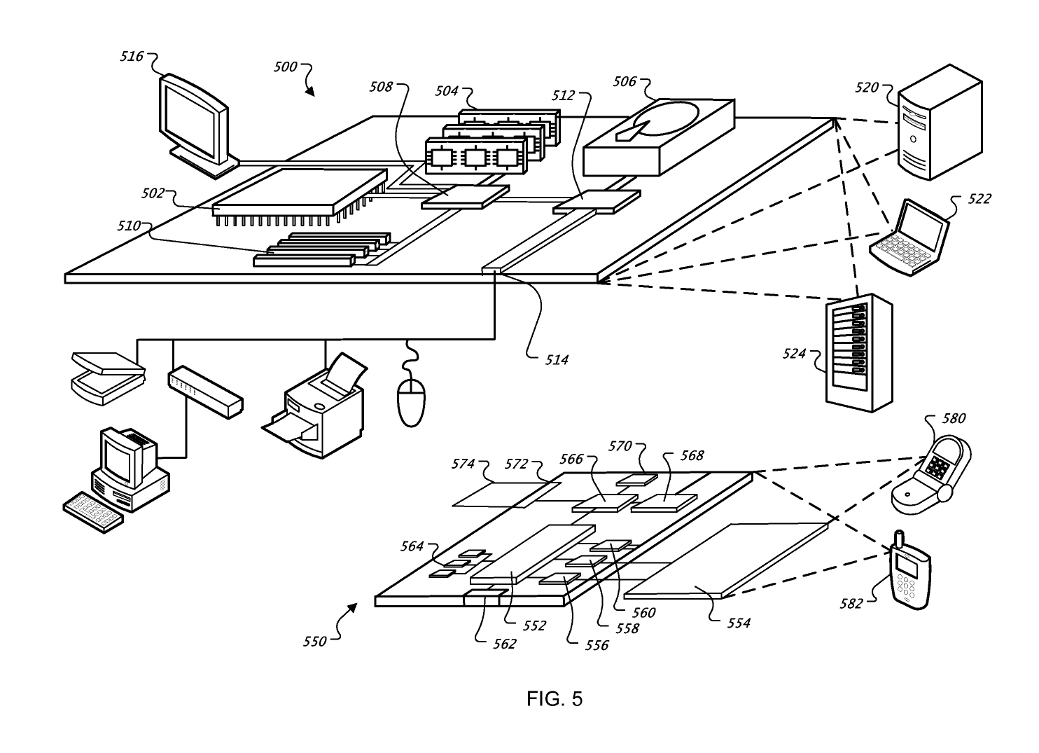

FIG. 5 shows an example of a generic computer device 500 and a generic mobile computer device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, memory on processor 502, or a propagated signal.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention. For example, an image of words describing the product can be used with optical character recognition software to provide search terms. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1-20. (canceled)

21. A method performed by one or more computing devices, comprising:
receiving an image over a computer network, the image comprising an object and having feature points that distinguish the object;
obtaining feature points from the received image;
comparing obtained feature points from the received image to feature points of images stored in an image library comprised of images having previously-obtained feature points, wherein images stored in the library have metadata tags that identify at least one aspect of the images;
identifying, based on the comparing, an image from the image library that is a candidate for matching the object, the candidate having at least some feature points in common with the received image;
associating metadata tags from the candidate image with the object;
using the metadata tags to conduct an online search for information relevant to the object;
outputting at least some of the information for use in generating a graphical display on a computing device;
receiving a response to the graphical display; and
performing an action in reply to the response.

22. The method of claim 21, wherein the object is a first object, and the response comprises receiving a second image comprising a second object; and
wherein performing the action comprises repeating the obtaining, comparing, identifying, associating, using, and outputting using the second image in place of the first image and the second object in place of the first object.

23. The method of claim 21, wherein the response comprises receiving an information command, the information command requesting additional information about an item included in the graphical display; and
wherein performing the action comprises:
identifying a type of the item;
conducting a second online search for the type of the item; and
outputting results of the second online search for using in generating a second graphical display.

24. The method of claim 21, wherein the response comprises receiving a command to provide more results; and
wherein performing the action comprises outputting more of the information for use in generating a graphical display.

25. The method of claim 21, wherein the graphical display comprises a product for purchase, the product corresponding substantially to the object; and
wherein performing the action comprises:
authenticating a purchaser of the product;
identifying a vendor of the product and communicating with the vendor regarding purchase of the product;
transmitting a checkout page to a computing device of the purchaser, the checkout page identifying at least the product, the vendor, and a price of the product;
receiving confirmation of purchase from the computing device via the checkout page; and
initiating the purchase.

26. The method of claim 21, wherein obtaining the feature points comprises performing optical character recognition on text associated with the object.

27. The method of claim 21, wherein the image is part of a collection of images received over the computer network, the images in the collection comprising objects and having feature points that distinguish the objects;
wherein obtaining comprises obtaining feature points from the images in the collection;
wherein comparing comprises comparing obtained feature points from the images in the collection to feature points of images stored in the image library; and
wherein identifying comprises identifying the image from the library that is a candidate for matching the objects, the candidate having at least some feature points in common with the images in the collection.

28. The method of claim 21, wherein the received image is a first image, the object is a first object, and the response comprises receiving a second image comprising a second object; and
wherein performing the action comprises:
obtaining feature points from the second image;
comparing obtained feature points from the second image to feature points of images stored in the image library; and
identifying an image from the image library that is a candidate for matching both the first object and the second object, the candidate having at least some feature points in common with the first object and the second object.

29. One or more non-transitory machine-readable storage media storing instructions that are executable by one or more processing devices to perform operations comprising:
identifying an object in an image received via a computer network, the object being identified by comparing display elements of the received image to display elements of other images that are part of an image library;
extracting descriptive tags from an image in the image library having display elements that correspond, at least in part, to the display elements of the received image;
performing a search of online sites for objects having at least one feature in common with the object in the received image, the search being performed using the extracted descriptive tags; and
outputting results of the search for display on a computing device, the results comprising objects having at least one feature in common with the object in the received image.

30. The one or more non-transitory machine-readable storage media of claim 29, wherein the object comprise a product for purchase; and
wherein the operations further comprise outputting, along with the results of the search, information for generating purchase buttons on a display screen, the purchase buttons being associated with products that are part of the search results and being operable to initiate purchase of the products.

31. The one or more non-transitory machine-readable storage media of claim 29, wherein the object in the received image is a first object; and wherein the operations further comprise:
in response to the search results, receiving a second image having a second object that has at least one feature in common with the first object;
using one or more descriptive tags associated with the second image to refine the search; and
outputting additional search results obtained via the refined search.

32. The one or more non-transitory machine-readable storage media of claim 29, wherein the descriptive tags comprise metadata tags, and wherein the display elements comprise feature points, the feature points comprising at least one of (i) an area of the image that changes suddenly, and (ii) text contained in the image.

33. The one or more non-transitory machine-readable storage media of claim 29, wherein the descriptive tags are extracted from more than one image in the image library having display elements that correspond, at least in part, to the display elements of the received image.

34. The one or more non-transitory machine-readable storage media of claim 29, wherein the operations further comprise:
identifying plural objects in plural images received via the computer network, the plural objects being identified by comparing display elements of the received plural images to display elements of other images that are part of the image library;
wherein extracting comprises extracting the descriptive tags from one or more images in the image library having display elements that correspond, at least in part, to display elements of the received plural images.

35. A system comprising:
a feature point generator to identify feature points in an image received via a computer network, the received image comprising an object distinguished by the feature points, the feature points corresponding to at least one of text in the image relating to the object and a variation between a feature of the object and features bounding the object;
an image comparator to compare feature points of the received image to feature points of other images that are part of an image library, and to identify a candidate image in the image library having at least some feature points that correspond to feature points of the received image, the candidate image having descriptive tags stored in association therewith in the image library; and
a search engine to (i) to perform an online search using at least some of the descriptive tags for objects having at least one feature in common with the object in the received image, the at least one feature being defined by the at least some of the descriptive tags, and (ii) to output results of the online search for display on a computing device, the results comprising one or more objects having at least one feature in common with the object in the received image;
wherein the feature point generator, image comparator, and the search engine are executable on one or more processing devices.

36. The system of claim 35, wherein the one or more objects comprises a product for purchase; and
wherein the system further comprises:
a payment authenticator to authenticate a purchaser of the product;
a transaction module to identify a vendor of the product and to communicate with the vendor regarding purchase of the product; and
a checkout interface module to transmit a checkout page to a computing device of the purchaser, the checkout page identifying at least the product, the vendor, and a price of the product, and to receive confirmation of purchase from the computing device via the checkout page.

37. The system of claim 35, wherein the search engine is configured to output, along with the results of the online search, information for generating purchase buttons for display on a display screen, the purchase buttons being associated with the one or more objects and being operable to initiate purchase of the one or more objects.

38. The system of claim 35, wherein the feature point generator is configured to identify feature points in plural images received via a computer network, the received image being among the plural received images, the received images comprising objects distinguished by the feature points, the feature points corresponding to at least one of text in the image relating to an object and a variation between a feature of the object and features bounding the object;
wherein the image comparator is configured to compare feature points of the received images to feature points of other images that are part of the image library, and to identify the candidate image in the image library having at least some feature points that correspond to feature points of the received images, the candidate image having descriptive tags stored in association therewith in the image library; and
wherein the search engine is configured (i) to perform an online search using at least some of the descriptive tags for objects having at least one feature in common with the objects in the received images, the at least one feature being defined by the at least some of the descriptive tags, and (ii) to output results of the online search for display on a computing device, the results comprising one or more objects having at least one feature in common with the objects in the received images.

39. The system of claim 35, wherein the received image is a first image and the object in the received image is a first object;
wherein the feature point generator is configured to identify second feature points in a second image received via a computer network, the second image comprising a second object distinguished by the second feature points;
wherein the image comparator is configured to compare second feature points of the second image to feature points of other images that are part of an image library, and to identify a second candidate image in the image library having at least some feature points that correspond to second feature points of the second image, the second candidate image having second descriptive tags stored in association therewith in the image library; and
wherein the search engine is configured (i) to perform an online search using at least some of the first descriptive tags and at least some of the second descriptive tags for objects having at least one feature in common with the first object, the at least one feature being defined by the at least some of the first descriptive tags and at least some of the second descriptive tags, and (ii) to output results of the online search for display on a computing device, the results comprising one or more objects having at least one feature in common with the first object in the first image.

40. The system of claim 35, wherein, in response to a command from the computing device, the feature point generator is configured to identify second feature points in second image via a computer network, the second image comprising a second object distinguished by the second feature points;
wherein the image comparator is configured to compare second feature points of the second image to feature points of other images that are part of an image library, and to identify a second candidate image in the image library having at least some feature points that correspond to second feature points of the second image, the second candidate image having second descriptive tags stored in association therewith in the image library; and
wherein the search engine is configured (i) to perform an online search using at least some of the second descriptive tags for objects having at least one feature in common with the second object, the at least one feature being defined by the at least some of the second descriptive tags, and (ii) to output results of the online search for display on a computing device, the results comprising one or more objects having at least one feature in common with the second object in the second image.
